(19) United States
(12) Patent Application Publication
(10) Pub. No.: US 2007/0066753 A1
(43) Pub. Date: Mar. 22, 2007

(54) Highly processible compounds of high MW conventional block copolymers and controlled distribution block copolymers

(76) Inventors: Martin L. Ehrlich, Houston, TX (US); Kathryn Wright, Katy, TX (US)

Correspondence Address: KRATON POLYMERS U.S. LLC, WESTHOLLOW TECHNOLOGY CENTER, 3333 HIGHWAY 6 SOUTH, HOUSTON, TX, 77082, US

(21) Appl. No.: 11/228,107

(22) Filed: Sep. 16, 2005

(51) Int. Cl. C08L 53/00

(52) U.S. Cl. 525/89

(57) ABSTRACT

The present invention provides a polymeric compound (e.g., a compounded polymeric composition) of highly improved processibility that includes a conventional block copolymer, a controlled distribution block copolymer, and optionally one or more components selected from the group consisting of olefin polymers, styrene polymers, tackifying resins, extending oils, waxes, fillers, and engineering thermoplastic resins. The controlled distribution block copolymer is used as a flow modifier to enhance processability of the conventional block copolymer compound. The polymeric compound of the present invention suffers no reduction in mechanic properties while exhibiting improved processability. One advantage of the present invention is that high performance rubber compounds can be made which can be more easily thermally processed relative to prior art compounds. As such, lower energy consumption, reduced cycle times, reduced part warpage, and/or increasing mold complexity can be achieved.

### FIELD OF THE INVENTION

The present invention relates to a compounded polymeric composition and more particularly to a compounded polymeric composition (e.g., polymeric compound) with improved processability. Improved processability can be realized in the form of reduced cycle times, reduced energy consumption, reduced temperature profiles, reduced part warpage, reduced surface defects, and/or reduced processing torque or pressure. The polymeric compound of the present invention includes a conventional block copolymer in conjunction with a controlled distribution block copolymer to improve processability of a polymer composition. Polymeric compounds of the present invention maintain desirable physical properties, yet allow for significantly reduced processing conditions such as temperatures, torque, and/or pressure.

### BACKGROUND OF THE INVENTION

It is known that a block copolymer can be obtained by an anionic copolymerization of a conjugated diene compound and an aromatic vinyl compound by using an organic alkali metal initiator. These types of block copolymers are diversified in characteristics, ranging from rubber-like characteristics to resin-like characteristics, depending on the content of the aromatic vinyl compound.

When the content of the aromatic vinyl compound in the endblock is low (approximately 40 wt. % or less), the produced block copolymer is a so-called thermoplastic rubber. It is a very useful polymer which shows rubber elasticity in the unvulcanized state and is applicable for various uses such as moldings of shoe sole, etc.; impact modifier for polystyrene resins; adhesives; binders; etc.

Conventional block copolymers have been produced (see for example, U.S. Pat. No. Re 27,145) which comprise primarily those having a general structure:
A-B-A
wherein the two terminal polymer A blocks comprise thermoplastic polymer blocks of mono alkenyl arenes such as polystyrene, while the B block is a polymer block of a conjugated diene. The proportion of the thermoplastic terminal blocks to the center elastomeric polymer block and the relative molecular weights of each of these blocks is balanced to obtain a rubber having an optimum combination of properties such that it behaves as an elastic vulcanized rubber without requiring the actual step of vulcanization. Moreover, these block copolymers can be designed, not only with this important advantage, but also so as to be handled in thermoplastic forming equipment and are soluble in a variety of relatively low cost solvents.

While these block copolymers have a number of outstanding technical advantages, one of their principal limitations lies in their sensitivity to oxidation. This was due to their unsaturated character, which can be minimized by hydrogenating the copolymer, especially in the center section comprising the polymeric diene block. Hydrogenation may be effected selectively as disclosed in U.S. Pat. No. Re 27,145. These polymers are hydrogenated block copolymers having a configuration, prior to hydrogenation, of A-B-A wherein each of the A's is an alkenyl-substituted aromatic hydrocarbon polymer block and B is a butadiene polymer block wherein 30-80 mol percent of the condensed butadiene units in the butadiene polymer block have 1,2 configuration.

Thermal processing of the conventional block copolymers of the type described above can sometimes be very difficult especially when using moderate to high molecular weight analogs (true number average molecular weight on the order of about 55,000 g/mol or higher at 30% polystyrene content). Moreover, the required processing conditions can even cause degradation of some of the components resulting in less than desired physical properties. This can be partially offset by the usage of antioxidants or process stabilizers. A reduction in process condition severity is desirable in many applications to reduce cycle time, energy consumption, part warpage from molded-in stresses, and surface defects. In addition, a reduction in viscosity may allow increased flexibility for mold design and part complexity.

Recent work has described the preparation of controlled distribution block copolymers in which a mono alkenyl arene is incorporated in the diene mid block in a controlled fashion. See, for example, U.S. patent application Ser. 10/359,981, filed Feb. 6, 2003 and entitled “NOVEL BLOCK COPOLYMERS AND METHOD FOR MAKING SAME”. The entire contents of the '981 application are incorporated herein by reference. The fraction of the aromatic vinyl compound is increased without loss of elasticity. A new mid block structure is created which has unique features resulting in a higher glass transition temperature, lower order-disorder transition temperature, lower entanglement molecular weight, etc. when compared to an analogous diene mid block.

Articles in which the controlled distribution block copolymer is used as the major component have also been described. See, for example, U.S. Patent Application Publication Nos. 2003/0166776 A1 and 2003/0181585 A1. In these disclosures, polymeric additives can be incorporated into the controlled distribution block copolymer. Despite this teaching, these disclosures neither address the processability difficulties associated with conventional block copolymers nor how such difficulties can be improved.

There is thus a need for providing a means for improving the thermal processing of conventional block copolymers, which does not adversely affect the physical properties of formulations that include the same.

### SUMMARY OF THE INVENTION

The polymeric compound of the present invention includes:
(a) at least one block copolymer having at least one A₁ block and at least one B₁ block wherein (1) each A₁ block is a mono alkenyl arene homopolymer block having a number average molecular weight of from about 3,000 to about 60,000; (2) each B₁ block, prior to hydrogenation, is a conjugated diene hydrocarbon block having a number average molecular weight of from about 30,000 to about 300,000; and (3) the A₁ blocks constituting about 5 to about 40 weight percent of the copolymer;
(b) at least one controlled distribution block copolymer including at least one A₂ block and at least one B₂ block wherein (1) each A₂ block is a mono alkenyl arene homopolymer block and each B₂ block is a controlled distribution copolymer block of at least one conjugated diene and at least one mono alkenyl arene; (2) each A₂ block has a number average molecular weight from about 3,000 to about 60,000 and each B₂ block has a number average molecular weight from about 30,000 to about 300,000; (3) each B₂ block comprises terminal regions adjacent to the A₂ blocks that are rich in conjugated diene units and one or more regions not adjacent to the A₂ blocks that are rich in mono alkenyl arene units; (4) the total amount of mono alkenyl arene in the block copolymer is about 15 percent weight to about 80 percent weight; and (5) the weight percent of mono alkenyl arene in each B₂ block is from about 10 percent to about 75 percent; and
(c) optionally one or more components selected from the group consisting of, but not limited to: olefin polymers, styrene polymers, tackifying resins, extending oils, waxes, fillers, and engineering thermoplastic resins,
   wherein component (b), e.g., the controlled distribution block copolymer, is present in an amount that improves thermal processability of component (a), e.g., the “conventional” block copolymer.

In accordance with the present invention, the conventional or controlled distribution block copolymers may either be unhydrogenated, hydrogenated or a combination of hydrogenated and unhydrogenated.

In addition to polymeric compounds, the present invention also contemplates articles that include the polymeric compound of the present invention. Illustrative examples of some articles that can include the inventive polymeric compound are: films, sheets, multilayered laminates, injection molded articles, extruded profiles, coatings, bands, strips, profiles, moldings, foams, tapes, fabrics, threads, filaments, ribbons, fibers or fibrous webs.

It is emphasized that the polymeric compounds of the instant invention which include both conventional and controlled distribution block copolymers, as described above, have improved processability compared to the same compound containing only a conventional block copolymer, without exhibiting a significant reduction in mechanical properties. Thus, the polymeric compounds of the present invention represent an improvement over prior art polymeric compounds that include only the conventional block copolymer mentioned above. Thermal processing of selectively hydrogenated block copolymers can sometimes be very difficult especially when using moderate to higher molecular weight analogs (true number average molecular weights on the order of about 55,000 g/mol or higher at 30% styrene content). Moreover, the required processing conditions can even cause a degradation of some of the components resulting in less than desired physical properties. This can be partially offset by the usage of antioxidants or processing aids. This invention offers a means to improve thermal processability in the form of reduced energy consumption, lower temperature profiles, shorter cycle times, reduced surface defects, and/or lower torque or pressures without presenting any undesirable effect on mechanical performance. The present invention is surprising since it provides a process improvement which does not negatively impact formulations that are based on a conventional block copolymer.

### DETAILED DESCRIPTION OF THE INVENTION

The present invention utilizes a controlled distribution block copolymer to improve processability of a polymeric compound based on a conventional block copolymer. The polymeric compound of the present invention includes a conventional block copolymer, a controlled distribution block copolymer, and optionally one or more components selected from the group comprising olefin polymers, styrene polymers, tackifying resins, extending oils, waxes, fillers, and engineering thermoplastic resins. The addition of the controlled distribution block copolymer to the conventional block copolymer at modest levels improves processability, without significantly reducing mechanical properties. By “modest levels” it is meant that the ratio of the conventional block copolymer to the controlled distribution block copolymer is greater than or equal to 1:1 (the conventional block copolymer quantity is greater than or equal to the controlled distribution block copolymer quantity). In prior disclosures, the ratio of conventional block copolymers to controlled distribution block copolymers has been less than 1:1 (the conventional block copolymer quantity is less than the controlled distribution block copolymer quantity). One advantage of the present invention is that high performance rubber compounds can be made which have improved thermal processability relative to prior art compounds. As such, processing energy costs are lower, thermal degradation of the compound may be reduced and cycle times may be reduced.

As used herein, the phrase “amount that improves thermal processability of component (a)” refers to the improved thermal processability of component (a) that can be obtained when up to and including 50% of the original rubber content of component (a) is replaced by component (b). The term “original rubber content” denotes the amount of conventional block copolymer in the formulation when no controlled distribution block copolymer is utilized.

As stated above, the present invention provides a polymeric compound, i.e., compounded polymeric composition, which includes, as essential components, at least one conventional block copolymer and at least one controlled distribution copolymer. Each of these essential components will be described in greater detail herein below. The polymeric compound of the present invention may optionally include one or more components selected from the group consisting of, but not limited to: polyolefin polymers, styrene polymers, tackifying resins, extending oils, waxes, fillers and engineering thermoplastic resins.

In accordance with the present invention, the polymeric compound includes a conventional block copolymer that contains at least one conjugated diene and at least one mono alkenyl arene homopolymer which exhibits elastomeric properties and which has a 1,2-microstructure content prior to hydrogenation of about 7% to about 80%. Such block copolymers may contain up to about 60 percent by weight of mono alkenyl arene. The general configuration of the conventional block copolymer employed in the present invention is A₁-B₁, A₁-B₁-A₁, (A₁-B₁)ₙ, (A₁-B₁)ₙ-A₁, (A₁-B₁-A₁)ₙX, (A₁-B₁)ₙX or mixtures thereof, where n is an integer from 2 to about 30, preferably 2 to about 15, more preferably 2 to about 6, and X is coupling agent residue. In the above formulas, each A₁ block is a polymer block of mono alkenyl arene homopolymer and each B₁ block is a polymer block of a conjugated diene. The coupling agents used in the present invention include any conventional coupling agent known for use in such block copolymers. For example, the coupling agent may be a polyalkenyl coupling agent such as divinyl benzene, alkoxysilanes, aliphatic diesters and diglycidyl aromatic epoxy compounds.

In one preferred embodiment, the conventional block copolymer includes at least one A₁ block and at least one B₁ block wherein (1) each A₁ block is a mono alkenyl arene homopolymer block having a number average molecular weight of about 3,000 to about 60,000; (2) each B₁ block, prior to hydrogenation, is a conjugated diene hydrocarbon block having a number average molecular weight of about 30,000 to about 300,000; (3) the A₁ blocks constituting about 5 to about 40 weight percent of the copolymer; (4) the unsaturation of the B₁ block is less than 10% of the original unsaturation; and (5) the unsaturation of the A₁ blocks is above 80% of the original unsaturation. In another preferred embodiment, the conventional block copolymer is one wherein (1) each A₁ block is a mono alkenyl arene homopolymer block having a number average molecular weight of about 6,500 to about 45,000; (2) each B₁ block, prior to hydrogenation, is a conjugated diene hydrocarbon block having a number average molecular weight of about 40,000 to about 275,000; (3) the A₁ blocks constituting from about 15 to about 40 weight percent of the copolymer; (4) the unsaturation of the B₁ block is less than 5% of the original unsaturation; and (5) the unsaturation of the A₁ blocks is above 95% of the original unsaturation. Of the various formulas given above for the conventional block copolymer, those having the formula A₁-B₁-A₁ are particularly preferred herein.

The conventional block copolymer may be produced by any well known block polymerization or copolymerization procedure including the well known sequential addition of monomer technique, incremental addition of monomer technique or coupling technique as illustrated in, for example, U.S. Pat. Nos. 3,251,905; 3,390,207; 3,598,887 and 4,219,627. As is well known in the block copolymer art, tapered copolymer blocks can be incorporated in the multiblock copolymer by copolymerizing a mixture of conjugated diene and vinyl aromatic hydrocarbon monomers utilizing the difference in their copolymerization reactivity rates. Various patents describe the preparation of multiblock copolymers containing tapered copolymer blocks including U.S. Pat. Nos. 3,251,905; 3,265,765; 3,639,521 and 4,208,356, the entire disclosures of which are incorporated herein by reference.

Conjugated dienes which may be utilized to prepare the block copolymers (a) are those having from 4 to 8 carbon atoms and include 1,3-butadiene, 2-methyl-1,3-butadiene (isoprene), 2,3-dimethyl-1,3-butadiene, 1,3-pentadiene, 1,3-hexadiene, and the like. Mixtures of such conjugated dienes may also be used. The preferred conjugated dienes are butadiene, isoprene and mixtures thereof. As used herein, the term “butadiene” refers to 1,3-butadiene.

Vinyl aromatic hydrocarbons which may be utilized to prepare the copolymers (a) include styrene, o-methylstyrene, p-methylstyrene, p-tert-butylstyrene, 1,3-dimethylstyrene, alpha-methylstyrene, vinylnaphthalene, vinylanthracene and the like. The preferred vinyl aromatic hydrocarbon is styrene.

It should be observed that the above-described polymers and copolymers may, if desired, be readily prepared by the methods set forth above. However, since many of these polymers and copolymers are commercially available, it is usually preferred to employ the commercially available polymer as this serves to reduce the number of processing steps involved in the overall process. Some examples of commercially available conventional block copolymers that can be employed in the present invention include, but are not limited to: KRATON® G1651, KRATON® G1654 and KRATON® G1650, each commercially available from KRATON Polymers LLC; SEPTON® 4077, SEPTON® 4055, SEPTON® 4044, SEPTON® 4033, SEPTON® 8006 and SEPTON® 8004, each commercially available from Kurraray Co. Ltd.; CALPRENE® H6170 and DYNASOL® 3151, each commercially available from Dynasol; and TUFTEC® N504, commercially available from Asahi.

Another preferred conventional block copolymer employed in the present invention is a selectively hydrogenated block copolymer of the formula S-EB-S wherein S is styrene and EB stands for hydrogenated butadiene, e.g., ethylene-butylene. In the preferred S-EB-S block copolymer, the styrene end segments preferably have a number average molecular weight from about 6,500 to about 45,000, while the EB mid block typically has a number average molecular weight from about 40,000 to about 275,000. Moreover, when an S-EB-S block copolymer is employed, the styrene blocks preferably comprise from about 15 to about 40 weight % of the block copolymer, and the EB mid block comprises from about 60 to about 95 weight % of the selectively hydrogenated block copolymer. The S-EB-S block copolymer preferably includes a 1,2 butadiene content that is on the order of about 30% or greater.

Another component of the inventive compound is a controlled distribution block copolymer containing mono alkenyl arene end blocks and a unique mid block of a mono alkenyl arene and a conjugated diene, such as described in copending and commonly assigned U.S. patent application Ser. No. 10/359,981, filed Feb. 6, 2003 and entitled “NOVEL BLOCK COPOLYMERS AND METHOD FOR MAKING SAME”. The entire contents of the '981 application, particularly the anionic polymerization method described therein, are thus incorporated herein by reference. Surprisingly, the combination of (1) a unique control for the monomer addition, and (2) the use of diethyl ether or other modifiers as a component of the solvent (which is referred to as a “distribution agent”) results in a certain characteristic distribution of the two monomers (herein termed a “controlled distribution” polymerization, i.e., a polymerization resulting in a “controlled distribution” structure), and also results in the presence of certain mono alkenyl arene rich regions and certain conjugated diene rich regions in the polymer block.

For purposes hereof, “controlled distribution” is defined as a molecular structure having the following attributes: (1) terminal regions adjacent to the mono alkenyl arene homopolymer (“A₂”) blocks that are rich in conjugated diene units; (2) one or more regions not adjacent to the A₂ blocks that are rich in mono alkenyl arene units; and (3) an overall structure having relatively low mono alkenyl arene, e.g., styrene, blockiness. For the purposes hereof, “rich in” is defined as having greater than the average amount, preferably 5% greater than the average amount. This relatively low mono alkenyl arene blockiness can be shown by either the presence of only a single glass transition temperature (Tg) intermediate between the Tg's of either monomer alone, when analyzed using differential scanning calorimetry (“DSC”) thermal methods or via mechanical methods, or as shown via proton nuclear magnetic resonance (“H-NMR”) methods. The potential for blockiness can also be inferred from measurement of the UV-visible absorbance in a wavelength range suitable for the detection of polystyryllithium end groups during the polymerization of the B₂ block. A sharp and substantial increase in this value is indicative of a substantial increase in polystyryllithium chain ends. In such a process, this will only occur if the conjugated diene concentration drops below the critical level to maintain controlled distribution polymerization. Any mono alkylene arene monomer, such as, for example, styrene, that is present at this point will add in a blocky fashion. The term “styrene blockiness”, as measured by those skilled in the art using proton NMR, is defined to be the proportion of S (i.e., styrene) units in the polymer having two S nearest neighbors on the polymer chain. Although this discussion relates to styrene blockiness, it is appreciated by those skilled in the art that the same holds for any mono alkenyl arene monomer.

The styrene blockiness is determined after using H-1 NMR to measure two experimental quantities as follows: First, the total number of styrene units (i.e., arbitrary instrument units which, when a ratio is taken, cancel out) is determined by integrating the total styrene aromatic signal in the H-1 NMR spectrum from 7.5 to 6.2 ppm and dividing this quantity by 5 to account for the 5 aromatic hydrogens on each styrene aromatic ring. Second, the blocky styrene units are determined by integrating that portion of the aromatic signal in the H-1 NMR spectrum from the signal minimum between 6.88 and 6.80 to 6.2 ppm and dividing this quantity by 2 to account for the 2 ortho hydrogens on each blocky styrene aromatic ring. The assignment of this signal to the two ortho hydrogens on the rings of those styrene units which have two styrene nearest neighbors was reported in F. A. Bovey, High Resolution NMR of Macromolecules (Academic Press, New York and London, 1972), Chapter 6.

The styrene blockiness is simply the percentage of blocky styrene to total styrene units:
Blocky %=100 times (Blocky Styrene Units/Total Styrene Units)
Expressed thus, Polymer-Bd-S—(S)ₙ—S-Bd-Polymer, where n is greater than zero is defined to be blocky styrene. For example, if n equals 8 in the example above, then the blockiness index would be 80%. It is preferred in the present invention that the blockiness index be less than about 40. For some polymers, having styrene contents of ten weight percent to forty weight percent, it is preferred that the blockiness index be less than about 10. It should be noted that although the blockiness is described in terms of styrene, the above description holds for other mono alkenyl arenes.

It is noted that the controlled distribution block of this block copolymer employed in the present invention is not a random block in which the distribution of the monomer unit is statistical, nor is the controlled distribution block a tapered block in which there is a gradual change in the composition of the polymer chain from one monomer unit to another.

The general configuration of the controlled distribution block copolymer employed in the present invention is A₂-B₂, A₂-B₂-A₂, (A₂-B₂)ₙ, (A₂-B₂)ₙ-A₂, (A₂-B₂-A₂)ₙX, (A₂-B₂)ₙX or mixtures thereof, where n is an integer from 2 to about 30, preferably 2 to about 15, more preferably 2 to about 6, and X is a coupling agent residue. The coupling agents mentioned above can also be used in forming the controlled distribution block copolymer.

In the above formulas, A₂ is a mono alkenyl arene homopolymer and B₂ is a controlled distribution block copolymer of at least one conjugated diene and at least mono alkenyl arene homopolymer. The at least one conjugated diene is selected from butadiene and isoprene and the mono alkenyl arene includes the vinyl aromatic hydrocarbons mentioned above.

In a preferred embodiment of the present invention, the polymeric composition comprises:
(a) at least one selectively hydrogenated block copolymer of the formula S₁—B₁—S₁ wherein each S₁ block is styrene and the B₁ block is butadiene and wherein (1) each S₁ block has a number average molecular weight of from about 6,500 to about 45,000; (2) the B₁ block, prior to hydrogenation, has a number average molecular weight of from about 40,000 to about 275,000; (3) the S₁ blocks constituting from about 15 to about 40 weight percent of the copolymer; (4) the unsaturation of the B₁ block is less than 5% of the original unsaturation; and (5) the unsaturation of the S₁ blocks is above 95% of the original unsaturation,
(b) at least one selectively hydrogenated controlled distribution block copolymer comprising S₂—B/S—S₂, wherein each S₂ is styrene and B/S is butadiene/styrene and wherein (1) each B/S block is a controlled distribution copolymer block; (2) each S₂ block has a number average molecular weight from about 6,500 to about 45,000 and each controlled distribution block has a number average molecular weight from about 40,000 to about 275,000; (3) each controlled distribution block comprises terminal regions adjacent to the S₂ blocks that are rich in conjugated butadiene units and one or more regions not adjacent to the S₂ blocks that are rich in styrene; (4) the total amount of styrene in the block copolymer is about 18% percent weight to about 63% percent weight; and (5) the weight percent of styrene in each controlled distribution block is from about 5 percent to about 45% percent;
(c) at least one olefin polymer; and
(d) an extending oil, wherein component (b) is present in an amount that improves thermal processability of component (a).

As noted, in some embodiments of the present invention, the conventional and controlled distribution block copolymers employed in the present invention are selectively hydrogenated. Hydrogenation can be carried out via any of the several hydrogenation or selective hydrogenation processes known in the prior art. The hydrogenation of these block polymers and copolymers may be carried out by a variety of well established processes including hydrogenation in the presence of such catalysts as Raney Nickel, noble metals such as platinum, palladium and the like and soluble transition metal catalysts. Suitable hydrogenation processes which can be used are ones wherein the diene-containing polymer or copolymer is dissolved in an inert hydrocarbon diluent such as cyclohexane and hydrogenated by reaction with hydrogen in the presence of a soluble hydrogenation catalyst. For example, such hydrogenation has been accomplished using methods such as those taught in, for example, U.S. Pat. Nos. 3,494,942, 3,634,594, 3,670,054, 3,700,633 and Reexamination No. 27,145, the disclosures of which are incorporated herein by reference. Such processes are also disclosed in U.S. Pat. Nos. 3,113,986 and 4,226,952, the disclosures of which are incorporated herein by reference. Typically, hydrogenation is carried out under such conditions that at least about 90 percent of the conjugated diene double bonds have been reduced, and between zero and 10 percent of the arene double bonds have been reduced. Preferred ranges are at least about 95 percent of the conjugated diene double bonds reduced, and more preferably about 98 percent of the conjugated diene double bonds are reduced. Alternatively, it is possible to hydrogenate the polymer such that aromatic unsaturation is also reduced beyond the 10 percent level mentioned above. In that case, the double bonds of both the conjugated diene and arene may be reduced by 90 percent or more.

In accordance with the present invention, the conventional or controlled distribution block copolymers may either be unhydrogenated, hydrogenated or a combination of hydrogenated and unhydrogenated. It is most logical to pair a selectively hydrogenated conventional block copolymer with a selectively hydrogenated controlled distribution block copolymer or an unhydrogenated conventional block copolymer with an unhydrogenated controlled distribution block copolymer. In this way degradation of the unhydrogenated components is reduced. However, it is conceivable that an unhydrogenated conventional block copolymer would be combined with a selectively hydrogenated controlled distribution block copolymer or vice versa if degradation is not the prime concern. When a hydrogenated block copolymers is employed, the block copolymer has about 0-10% of the arene double bonds being reduced and at least about 90% of the conjugated diene bonds being reduced.

In an alternative, the conventional block copolymer and/or the controlled distribution block copolymer employed in the present invention may be functionalized in a number of ways. One way is by treatment with an unsaturated monomer having one or more functional groups or their derivatives, such as carboxylic acid groups and their salts, anhydrides, esters, imide groups, amide groups, and acid chlorides. The preferred monomers to be grafted onto the block copolymers are maleic anhydride, maleic acid, fumaric acid, and their derivatives. A further description of functionalizing such block copolymers can be found in U.S. Pat. Nos. 4,578,429 and 5,506,299. In another manner, the copolymers employed in the present invention may be functionalized by grafting silicon or boron-containing compounds to the polymer as taught, for example, in U.S. Pat. No. 4,882,384. In still another manner, the block copolymers of the present invention may be contacted with an alkoxy-silane compound to form silane-modified block copolymer. In yet another manner, the block copolymers of the present invention may be functionalized by reacting at least one ethylene oxide molecule to the polymer as taught in U.S. Pat. No. 4,898,914, or by reacting the polymer with carbon dioxide as taught in U.S. Pat. No. 4,970,265. Still further, the block copolymers of the present invention may be metallated as taught in U.S. Pat. Nos. 5,206,300 and 5,276,101, wherein the polymer is contacted with an alkali metal alkyl, such as a lithium alkyl. And still further, the block copolymers of the present invention may be functionalized by grafting sulfonic groups to the polymer as taught in U.S. Pat. No. 5,516,831.

In addition to the above two block copolymers, e.g., the conventional block copolymer and the controlled distribution block copolymer, the polymeric compound of the present invention may optionally include one or more components selected from the group consisting of, but not limited to: olefin polymers, styrene polymers, tackifying resins, extending oils, waxes, fillers, and engineering thermoplastic resins. In one embodiment of the present invention, it is preferred that an olefin polymer and an extending oil be used.

Olefin polymers that may optionally be used in the present invention include, for example, ethylene homopolymers, ethylene/alpha-olefin copolymers, propylene homopolymers, propylene/alpha-olefin copolymers, high impact polypropylene, butylene homopolymers, butylene/alpha olefin copolymers, and other alpha olefin copolymers or interpolymers. Other representative polyolefins include, but are not limited to: substantially linear ethylene polymers, homogeneously branched linear ethylene polymers, heterogeneously branched linear ethylene polymers, including linear low density polyethylene (LLDPE), ultra or very low density polyethylene (ULDPE or VLDPE), medium density polyethylene (MDPE), high density polyethylene (HDPE) and high pressure low density polyethylene (LDPE). Other polymers included hereunder are ethylene/acrylic acid (EEA) copolymers, ethylene/methacrylic acid (EMAA) ionomers, ethylene/vinyl acetate (EVA) copolymers, ethylene/vinyl alcohol (EVOH) copolymers, ethylene/cyclic olefin copolymers, propylene homopolymers and copolymers, propylene/styrene copolymers, ethylene/propylene copolymers, polybutylene, ethylene carbon monoxide interpolymers (for example, ethylene/carbon monoxide (ECO) copolymer, ethylene/acrylic acid/carbon monoxide terpolymer and the like. Preferably, the polyolefin is a polypropylene polymer or a copolymer including polypropylene, with polypropylene polymers being most preferred. When present, the olefin polymer is typically present in an amount from about 5 to about 100 parts by weight.

Styrene polymers that can optionally be used in the present invention include, for example, crystal polystyrene, high impact polystyrene, medium impact polystyrene, styrene/acrylonitrile copolymers, styrene/acrylonitrile/butadiene (ABS) polymers, syndiotactic polystyrene, styrene/methyl-methacrylate copolymers and styrene/olefin copolymers. Representative styrene/olefin copolymers are substantially random ethylene/styrene copolymers, preferably containing at least 10, more preferably equal to or greater than 25 weight percent copolymerized styrene monomer. Also included are styrene-grafted polypropylene polymers, such as those offered under the tradename INTERLOY® polymers, originally developed by Himont, Inc. (now Crompton). When present, the styrene polymer is typically present in an amount from about 5 to about 100 parts by weight.

For the purposes of the specification and claims, the term “engineering thermoplastic resin” encompasses polymers such as, thermoplastic polyesters, thermoplastic polyurethanes, poly(aryl ethers) and poly(aryl sulfones), polycarbonates, acetal resin, polyamide, halogenated thermoplastic, nitrile barrier resin, poly(methyl methacrylates), and cyclic olefin copolymers. These classes of polymers are further defined in U.S. Pat. No. 4,107,131, the disclosure of which is hereby incorporated by reference. When present, the thermoplastic resin is typically present in an amount from about 5 to about 100 parts by weight.

Tackifying resins that may optionally be used in the present invention include polystyrene block compatible resins and midblock compatible resins. The polystyrene block compatible resin may be selected from the group of, but not limited to: coumarone-indene resin, polyindene resin, poly(methyl indene) resin, polystyrene resin, vinyltoluene-alphamethylstyrene resin, alphamethylstyrene resin and polyphenylene ether, in particular poly(2,6-dimethyl-1,4-phenylene ether). Such resins are, e.g., sold under the trademarks “HERCURES”, “ENDEX”, “KRISTALEX”, “NEVCHEM” and “PICCOTEX”. Resins compatible with the (mid) block may be selected from the group consisting of, but not limited to: compatible C₅ hydrocarbon resins, hydrogenated C₅ hydrocarbon resins, styrenated C₅ resins, C₅/C₉ resins, styrenated terpene resins, fully hydrogenated or partially hydrogenated C₉ hydrocarbon resins, rosins esters, rosins derivatives and mixtures thereof. These resins are, e.g., sold under the trademarks “REGALITE”, “REGALREZ”, “ESCOREZ” and “ARKON”. When present, the tackifying resin is typically present in an amount from about 5 to about 50 parts by weight.

The polymeric compound of the present invention optionally may also include at least one extending oil. Especially preferred are the types of oils that are compatible with the elastomeric segment of the block copolymer, such as mineral oils. The term “mineral oil” includes petroleum-based oils such as, for example, paraffinic oil and naphthenic oil. While oils of higher aromatic contents may be satisfactory, those petroleum-based white mineral oils having low volatility and less than 50% aromatic content are preferred. Synthetic hydrocarbon oils can also be used in the present invention. Examples of synthetic hydrocarbon oils include, but are not limited to: polyalphaolefins such as DURASYN® Polyalphaolefins, polybutenes such as HYVIS®, NAPVIS®, and the like. Mixtures of oils are also contemplated in the present invention. In a preferred embodiment, the at least one extending oil is a mineral oil. When present, the extending oil is typically present in an amount from about 5 to about 400 parts by weight. When oil gels are being made using the composition of the present invention, the extending oil will typically be present in an amount up to about 4000 parts by weight. These oil gels may also contain one or more additives/components which are readily known in the art for use in oil gels such as polyolefins, waxes, fillers, pigments, dyes, colorants, antioxidants, aroma agents, flavoring agents, and blowing agents. Oil gels of this type may be employed as adherent gels, crystal gel, oriented gels, PE crystal gels, foamed gels or fluffy gels. In addition, such oil gels may be used in the preparation of composites by utilizing a variety of substrates such as paper, foam, plastic, fabric, metal, metal foil, metallic flakes, concrete, wood, glass, glass fibers, ceramics, synthetic resin, synthetic fibers, refractory materials and the like. Articles which can be made from said oil gels include, but are not limited to: hand exercising grips, crutch cushions, cervical pillows, bed wedge pillows, leg rests, neck cushions, mattresses, bed pads, elbow pads, dermal pads, wheelchair cushions, helmet liners, cold and hot packs, exercise weight belts, traction pads or belts, cushions for splints, slings, braces for the hand, wrist, finger, forearm, knee, leg, clavicle, shoulder, foot, ankle, neck, back or rib, soles for orthopedic shoes, optical claddings for cushioning optical fibers from bending stresses, swab tips, swabs, fishing bait, seals against pressure, threads, strips, yarns, tapes, woven cloths, fabrics, balloons for various uses, condoms, gloves, self sealing enclosures for splicing electrical and telephone cables and wires, cable filings, films, liners, simulated food, oral care articles such as dental floss, inflatable restraint cushions, toys (aerodynamic, rotating string, string, spinning/rotating), cold weather wear, air bags, artificial muscle actuator and the like.

The polymeric compound of the present invention optionally may also include at least one wax including for example, a polyolefin wax. Examples of polyolefin waxes include, but are not limited to: polyethylene wax, polypropylene wax and polybutylene. The molecular weights of the waxes employed may vary and are not critical for practicing the invention. When present, the wax is typically present in an amount from about 1 to about 30 parts by weight.

The inventive polymeric compound may also include various types of fillers and pigments. Examples of various fillers that can be employed are found in the 1971-1972 Modern Plastics Encyclopedia, pages 240-247. Suitable fillers include calcium carbonate, clay, talc, silica, zinc oxide, titanium dioxide, glass fibers, boron fibers, graphite fibers, whiskers, metal fibers, synthetic organic fibers and the like. The amount of filler employed in the present invention usually is in the range of 0 to 40% weight depending on the type of filler used and the application for which the polymeric compound is intended. Especially preferred fillers are titanium dioxide, calcium carbonate, talc, silica, and clay.

One preferred polymeric compound of the present invention includes: 100 parts by weight of combined conventional and controlled distribution block copolymers that are each selectively hydrogenated, wherein the controlled distribution block copolymer is present in an amount of less than or equal to 50 parts by weight; and about 5 to about 400 parts by weight of a polymer extending oil.

Another preferred polymeric compound of the present invention includes: 100 parts by weight of combined conventional and controlled distribution block copolymers that are each selectively hydrogenated, wherein the controlled distribution block copolymer is present in an amount of less than or equal to 50 parts by weight, and about 5 to about 100 parts by weight of an olefin polymer. The compound may also include about 5 to about 50 parts by weight of a tackifying resin and 1 to 20 parts by weight of an olefin wax.

A yet other preferred polymeric compound of the present invention includes: 100 parts by weight of combined conventional and controlled distribution block copolymers that are each unhydrogenated, wherein the controlled distribution block copolymer is present in an amount of less than or equal to 50 parts by weight; and about 5 to about 100 parts by weight of an styrenic polymer.

A further preferred polymeric compound of the present invention includes: 100 parts by weight of combined conventional and controlled distribution block copolymers that are each selectively hydrogenated, wherein the controlled distribution block copolymer is present in an amount of less than or equal to 50 parts by weight; about 5 to about 300 parts by weight of a polymer extending oil, and about 10 to about 40 parts by weight of a polyolefin.

The polymeric compound of the present invention may be modified further with the addition of other components such as other polymers, reinforcements, antioxidants, stabilizers, fire retardants, anti blocking agents, suntan screens, lubricants and other rubber and plastic compounding ingredients without departing from the scope of this invention. When such components are present, they may be present individually or collectively in any amount effective for the intended purpose as is commonly known by those of ordinary skill in the art, for instance from as little as about 0.001 w % (as for example in the case of antioxidants) to as high as about 97 w % (as in the case of fillers or oils). Such components are disclosed in various patents including, for example, U.S. Pat. Nos. 3,239,478 and 5,777,043, the disclosures of which are incorporated by reference.

Regarding the relative amounts of the various ingredients, this will depend in part upon the particular end use and on the particular block copolymers that are selected for the particular application provided the controlled distribution block copolymer is present in an equal or a lesser amount than that of the conventional block copolymer. Table A below shows some notional compositions expressed in percent weight, which are included in the present invention.

TABLE A

| | | Composition |
|---|---|---|
| Application | Ingredients | % w. |
| Films, Molding, Alloys | Conventional block | 0.5-90% |
| | copolymer | |
| | Controlled distribution | 0.1-49% |
| | block copolymer | |
| | Ethylene copolymers: | 0-99% |
| | EVA, Ethylene/styrene | |
| Personal Hygiene Films | Conventional block | 5-68% |
| and Fibers | copolymer | |
| | Controlled distribution | 1-37% |
| | block copolymer | |
| | PE | 0-30% |
| | PP | 0-30% |
| | Tackifying Resin | 5-30% |
| | End Block Resin | 5-20% |
| Personal Hygiene Films | Conventional block | 25-80% |
| and Fibers | copolymer | |
| | Controlled distribution | 5-45% |
| | block copolymer | |
| | PE | 5-30% |
| | Tackifying Resin | 0-40% |
| Personal Hygiene Films | Conventional block | 22-80% |
| and Fibers | copolymer | |
| | Controlled distribution | 4.5-45% |
| | block copolymer | |
| | PS | 10-50% |
| | Oil | 0-30% |
| Injection Molded | Conventional block | 12-90% |
| Articles | copolymer | |
| | Controlled distribution | 2.5-50% |
| | block copolymer | |
| | Polyolefin | 0-50% |
| | PS | 0-50% |
| | Oil | 0-50% |
| Injection Molded/Extrusion | Conventional block | 27-80% |
| | copolymer | |
| | Controlled distribution | 5.5-45% |
| | block copolymer | |
| | PPO | 0-50% |
| | PS | 0-50% |
| | Engineering Plastic | 0-50% |
| | Filler | 0-50% |
| | Oil | 0-50% |
| Cap Seals | Conventional block | 12-55% |
| | copolymer | |
| | Controlled distribution | 2.5-30% |
| | block copolymer | |
| | Oil | 0-50% |
| | PP and/or Tackifying | 0-50% |
| | Resin | |
| | Filler | 0-25% |
| | Lubricant | 0-3% |
| Engineering Thermoplastic | Conventional block | 2.5-27% |
| Toughening | copolymer (or maleated) | |
| | Controlled distribution | 0.5-15% |
| | block copolymer | |
| | (or maleated) | |
| | Engineering thermo- | 70-95% |
| | plastic, e.g. Nylon | |
| | 6,6, PPO, SAN | |
| Oil Gels | Conventional block | 1.5-20% |
| | copolymer | |
| | Controlled distribution | 0.1-10% |
| | block copolymer | |
| | Oil | 80-97% |
| Ultra-Soft Articles | Conventional block | 7-27% |
| | copolymer | |
| | Controlled distribution | 1.5-15% |
| | block copolymer | |
| | Oil | 70-85% |

The polymeric compound of the present invention is made using techniques that are well known in the art. For example, the polymeric compound of the present invention can be made by blending at least the aforementioned described components together. The blends can be made using any conventional mixing apparatus and conditions known to one skilled in the art.

The polymeric compounds of the present invention can be made into various articles including, but not limited to: injection molded toys, medical devices, and automotive parts, such as airbags, steering wheels, etc,; extruded films, tubing, profiles; over molding applications for personal care, grips, soft touch applications; dipped goods, such as gloves; thermoset applications, such as in sheet molding compounds or bulk molding compounds for trays; roto molded toys and other articles; slush molded automotive skins; thermally sprayed coatings; blown film for medical devices; blow molded automotive/industrial parts; molded ultra-soft articles and oil gels; and films and fibers for personal hygiene applications.

The articles including the inventive polymeric compound are made using processing techniques well known in the art. For example, the articles can be made by extrusion, injection molding, blow molding, slush molding, compression molding, dipping, roto molding, fiber spinning, cast film making, foaming and the like.

It is observed that the present invention provides a means by which the processing requirements for conventional block copolymers such as, high molecular weight selectively hydrogenated block copolymers, particularly S-EB—S, can be greatly reduced without significantly affecting the physical properties of the resultant polymeric compound. This same general affect is true for other types of conventional block copolymers as well.

It has unexpectedly been found that by replacing up to 50% of the original rubber content in a selectively hydrogenated block copolymer\polyolefin\oil compound with a selectively hydrogenated controlled distribution block copolymer, as described above, a polymeric compound that has improved processability in terms of reduced compression molding temperatures and higher melt flow rates is achieved. These properties can be improved, while maintaining high tensile strength and elongation. In addition, the applicants have unexpectedly found that by replacing up to 40% of the original rubber content in a selectively hydrogenated block copolymer\tackifying resin\wax compound with a controlled distribution block copolymer, as described above, results in a polymeric compound that has improved processability in terms of reduced energy consumption (reduced pressures). This improvement in processability is realized without any significant reduction in mechanical properties.

Specifically, an increase in compound melt flow or a reduction in the amount of energy required to produce adequate mixing indicate that the controlled distribution block copolymer is used in the present invention as a flow modifier for polymeric compounds that include S-EB—S and other like conventional block copolymers without deteriorating any of the physical properties, such as tensile strength, elongation, and hysteresis of the polymeric compounds.

The following examples are provided to illustrate the inventive composition. These examples are merely exemplary and are not intended to limit the scope of the invention.

In the Example 1, the following compounds were used:
KRATON® G-1651H=a conventional S-EB—S block copolymer with 33% polystyrene content supplied by KRATON Polymers LLC.
KRATON® RP6935=a controlled distribution block copolymer having the formula S-EB/S—S with 58% polystyrene content supplied by KRATON Polymers LLC. The true molecular weight of RP6935 is identical to that of G-1651H.
DRAKEOL® 34=a paraffinic mineral oil supplied by Penreco.
PP 5A15H®=a 5MF polypropylene homopolymer supplied by Dow Chemical Company.
IRGANOX® 1010=a hindered phenolic antioxidant supplied by Ciba Specialty Chemicals.

In Example 2, the following compounds were used:
KRATON® MD6937=a conventional SEBS block copolymer with 19% polystyrene content supplied by KRATON Polymers LLC.
KRATON® RP6936=a controlled distribution block copolymer with 40% polystyrene content having the formula S-EB/S—S supplied by KRATON Polymers LLC.
REGALREZ® 1126=a tackifying resin supplied by Eastman Chemical Company.
EPOLENE® C-10=a polyethylene wax supplied by Eastman Chemical Company.
ETHANOX® 330=a hindered phenolic antioxidant supplied by Ciba Specialty Chemicals.

Amounts in each of the examples are in parts per hundred rubber (phr) unless otherwise specified. The test methods used in the examples are either American Society for Testing Materials (ASTM) test methods or methods that have been slightly modified from a corresponding ASTM test method. Table B provides the specific methods that were used in the following examples.

TABLE B

| TEST | ASTM No. |
|---|---|
| Melt Flow Rate at 230° C./5 kg | D1238 |
| Tensile Strength, psi Elongation, | Internal method similar to D412 |
| % | using crosshead displacement to |
| | measure strain and a miniature |
| | dogbone with a 1″ gage length |
| Compression Set, % (70° C., 22 hrs) | D395 |

### EXAMPLE 1

In this Example, the use of a controlled distribution block copolymer as a flow modifier in a high molecular weight SEBS formulation was demonstrated. Formulations A-E as shown in Table 1 were processed in a BRABENDER® mixer; mixing was performed at 230° C. (i.e., 414° F.) and at a mixing speed of 100 rpm. All formulations were further compression molded at 425° F. (i.e., approximately 218.3° C.) and approximately 1000 psi. The formulations were then water cooled to approximately 125° F. (i.e., approximately 51.7° C.) before demolding. Formulation A, containing a conventional SEBS block copolymer only, needed to be molded hotter than 425° F. (i.e., approximately 218.3° C.) to achieve uniform sample continuity and integrity because of poor compound flow.

Formulations A, D and E are provided for comparison and Formulations B—C are representative of the present invention. Table 1 also includes, in addition to the ingredients present in each formulation, the results of various physical testing as well as the temperature at which molding took place.

TABLE 1

| | FORMULATION | | | | |
|---|---|---|---|---|---|
| | A | B | C | D | E |
| G-1651H | 100 | 75 | 50 | 25 | 0 |
| RP6935 | 0 | 25 | 50 | 75 | 100 |
| DRAKEOL ® 34 | 100 | 100 | 100 | 100 | 100 |
| PP 5A15H ® | 30 | 30 | 30 | 30 | 30 |
| IRGANOX ® 1010 | 0.3 | 0.3 | 0.3 | 0.3 | 0.3 |
| Melt Flow, dg/min | 5.8 | 6.9 | 15.3 | 37.6 | 90.2 |
| Molding | 425 | 425 | 425 | 425 | 425 |
| Temperature, ° F. | | | | | |
| 50% Modulus, psi | 130 | 130 | 120 | 135 | 125 |
| 300% Modulus, psi | 220 | 360 | 370 | 410 | 400 |
| Tensile Strength, psi | 280 | 2625 | 2420 | 2185 | 1715 |
| Elongation, % | 290 | 1255 | 1185 | 1080 | 980 |
| Compression Set, % | 70 | 70 | 70 | 70 | N/A |
| (70° C., 22 hrs) | | | | | |

The formulations including both conventional and less than or equal to 50% of a controlled distribution block copolymers, i.e., Formulations B—C, had higher melt viscosity than Formulation A which included only a conventional block copolymer. This is true despite the fact that both the conventional and controlled distribution block copolymers have the same total molecular weights. This example illustrates that a controlled distribution block copolymer can be used as a flow modifier in formulations based on conventional SEBS block copolymers, without deterioration of physical properties. Specifically, with as little as 25 phr controlled distribution block copolymer added to the formulation, high tensile properties were achieved at the same molding temperature. Continued addition of up to 50% of the controlled distribution block copolymer results in similar tensile properties with increased melt flow. However, when 75% of the traditional block copolymer is replaced with the controlled distribution block copolymer, the tensile strength and elongation of the formulation is reduced.

It is noted that in order to achieve desirable tensile properties from formulation A, a molding temperature of at least 450° F. (i.e., approximately 232.2° C.) is needed as shown in Table 2 below. Formulation B, however, maintained good tensile properties at a molding temperature as low as 375° F. (i.e., approximately 190.6° C.). Therefore, the addition of a controlled distribution block copolymer to a conventional block copolymer formulation reduced molding temperature without sacrificing tensile, elongation and compression set properties.

TABLE 2

| | Formulation | | |
|---|---|---|---|
| | A | B | B |
| Molding Temperature, ° F. | 450 | 400 | 375 |
| 50% Modulus, psi | 130 | 135 | 135 |
| 300% Modulus, psi | 340 | 375 | 135 |
| Tensile Strength, psi | 2720 | 2900 | 2400 |
| Elongation, % | 1355 | 1270 | 1120 |

### EXAMPLE 2

In Example 2, the use of a controlled distribution block copolymer as a process aid in a low-medium molecular weight SEBS formulation was demonstrated. Formulations F—H below (see Table 3) serve as an example to illustrate the process improvement by progressive replacement of a conventional copolymer by a controlled distribution copolymer. All formulations were compounded on a 40 mm co-rotating twin screw extruder using the temperature profile below:

| Feed Zone | 150° F. (approximately 65.5° C.) |
|---|---|
| Zone 2 | 380° F. (approximately 193.3° C.) |
| Zone 3 | 425° F. (approximately 218.3° C.) |
| Zone 4 | 460° F. (approximately 237.8° C.) |
| Zone 5 | 460° F. (approximately 237.8° C.) |
| Zone 6 | 450° F. (approximately 232.2° C.) |
| Zone 7 | 450° F. (approximately 232.2° C.) |
| Die Zone | 450° F. (approximately 232.2° C.) |
| % Load | 55 |

Formulations were subsequently fabricated into film using a Film Master blown film line with a BRABENDER® extruder equipped with four temperature zones, 2″ diameter die, 1″ conventional screw with a 15:1 L/D, adjustable collapsible frame, and ambient air cooling. The processing conditions used are listed below:

| | |
|---|---|
| Zone 1 | 200° C. (approximately 392° F.) |
| Zone 2 | 220° C. (approximately 428° F.) |
| Zone 3 | 220° C. (approximately 428° F. |
| Die Zone | 225° C. (approximately 437° F.) |
| Ext. Speed | 120 RPM |

Formulation F is the control where all of the block copolymer portion is of the conventional SEBS type. By replacing 25% and 40% of the conventional copolymer with a controlled distribution copolymer the pressure in the blown film operation was reduced by 25% and 30%, respectively. This improvement in processability was achieved without any reduction in machine direction tensile or hysteresis properties.

TABLE 3

| | Formulation | | |
|---|---|---|---|
| | F | G | H |
| MD6937 | 100 | 75 | 60 |
| RP6936 | 0 | 25 | 40 |
| Regalrez 1126 | 16 | 16 | 16 |
| Epolene C-10 | 8.7 | 8.7 | 8.7 |
| Ethanox 330 | 0.2 | 0.2 | 0.2 |
| Pressure, psi | 2000 | 1500 | 1400 |
| 100% Modulus, psi | 240 | 240 | 235 |
| 300% Modulus, psi | 440 | 440 | 420 |
| Tensile Strength, psi | >4000 | >4000 | >4000 |
| Elongation, % | >700 | >700 | >700 |
| Cyclic Hysteresis to 300% Strain | | | |
| Peak Stress, psi | 365 | 345 | 345 |
| Recoverable energy after 1 cycle, % | 70 | 69 | 69 |
| Permanent set after 1 cycle, % | 17 | 18 | 18 |

While the present invention has been particularly shown and described with respect to preferred embodiments thereof, it will be understood by those skilled in the art that the foregoing and other changes in forms and details may be made without departing from the spirit and scope of the present invention. It is therefore intended that the present invention not be limited to the exact forms and details described and illustrated, but fall within the scope of the appended claims.

What is claimed is:

1. A polymeric compound comprising:
(a) at least one block copolymer including at least one A₁ block and at least one B₁ block wherein (1) each A₁ block is a mono alkenyl arene homopolymer block having a number average molecular weight of about 3,000 to about 60,000; (2) each B₁ block, prior to hydrogenation, is a conjugated diene hydrocarbon block selected from butadiene, isoprene and mixtures thereof having a number average molecular weight of about 30,000 to about 300,000; and (3) the A₁ blocks constituting about 5 to about 40 weight percent of the copolymer; and
(b) at least one controlled distribution block copolymers including at least one A₂ block and at least one B₂ wherein (1) each A₂ block is a mono alkenyl arene homopolymer block and each B₂ block is a controlled distribution copolymer block of at least one conjugated-diene selected from butadiene and isoprene and at least one mono alkenyl arene; (2) each A₂ block has a number average molecular weight from about 3,000 to about 60,000 and each B₂ block has a number average molecular weight from about 30,000 to about 300,000; (3) each B₂ block comprises terminal regions adjacent to the A₂ blocks that are rich in conjugated diene units and one or more regions not adjacent to the A₂ blocks that are rich in mono alkenyl arene units; (4) the total amount of mono alkenyl arene in the block copolymer is about 15 percent weight to about 80 percent weight; and (5) the weight percent of mono alkenyl arene in each B₂ block is from about 10 percent to about 75 percent,
wherein the polymers of (a) and (b) are either selectively hydrogenated or unhydrogenated and the ratio of (a) to (b) is greater than or equal to 1:1.

2. The polymeric compound of claim 1 further comprising (c) one or more components selected from the group consisting of olefin polymers, styrene polymers, tackifying resins, extending oils, waxes, fillers, and engineering thermoplastic resins.

3. The polymeric compound of claim 1 wherein said at least one block copolymer (a) has the formula A₁-B₁-A₁ or (A₁-B₁)ₙX wherein n is between 1 and 30, and X is a coupling agent residue and wherein said at least one controlled distribution block copolymer (b) has the formula A₂-B₂-A₂ or (A₂-B₂)ₙX wherein n is between 1 and 30, and X is a coupling agent residue.

4. The polymeric compound of claim 1 wherein:
each A₁ block of the block copolymer (a) is a mono alkenyl arene homopolymer block having a number average molecular weight of about 6,500 to about 45,000; each B₁ block, prior to hydrogenation, is a conjugated diene hydrocarbon block having a number average molecular weight of about 40,000 to about 275,000; the A₁ blocks constituting from about 15 to about 40 weight percent of the copolymer; the unsaturation of the B₁ block is less than 5% of the original unsaturation; and the unsaturation of the A₁ blocks is above 95% of the original unsaturation; and
each A₂ block of the block copolymer (b) is a mono alkenyl arene homopolymer block having a number average molecular weight of about 6,500 to about 45,000; each B₂ block, prior to hydrogenation, is a conjugated diene hydrocarbon block having a number average molecular weight of about 40,000 to about 275,000; the A₂ blocks constituting from about 15 to about 63 weight percent of the copolymer; the unsaturation of the B₂ block is less than 5% of the original unsaturation; and the unsaturation of the A₂ blocks is above 95% of the original unsaturation.

5. The polymeric compound of claim 1 wherein said at least one controlled distribution block copolymer (b) comprises styrene as said mono alkenyl arene and butadiene as said conjugated diene.

6. The polymeric compound of claim 5 wherein about 15 to about 80 mol percent of the conjugated butadiene units in the B₂ block have a 1,2-configuration.

7. The polymeric compound of claim 2 wherein said one or more components is an olefin polymer comprising at least one of ethylene homopolymers, ethylene/alpha-olefin copolymers, propylene homopolymers, propylene/alpha-olefin copolymers, high impact polypropylene, butylene homopolymers, butylene/alpha olefin copolymers, linear low density polyethylene (LLDPE), ultra or very low density polyethylene (ULDPE or VLDPE), medium density polyethylene (MDPE), high density polyethylene (HDPE), high pressure low density polyethylene (LDPE), ethylene/acrylic acid (EEA) copolymers, ethylene/methacrylic acid (EMAA) ionomers, ethylene/vinyl acetate (EVA) copolymers, ethylene/vinyl alcohol (EVOH) copolymers, ethylene/cyclic olefin copolymers, propylene/styrene copolymers, ethylene carbon monoxide interpolymers, or ethylene/acrylic acid/carbon monoxide terpolymers.

8. The polymeric compound of claim 7 wherein said olefin is polypropylene or a propylene copolymer.

9. The polymeric compound of claim 2 wherein said one or more components is a styrene polymer comprising at least one of crystal polystyrene, high impact polystyrene, medium impact polystyrene, styrene/acrylonitrile copolymers, styrene/acrylonitrile/butadiene (ABS) polymers, syndiotactic polystyrene, styrene/methyl-methacrylate copolymers or styrene/olefin copolymers.

10. The polymeric compound of claim 2 wherein said one or more components is an extending oil comprising a mineral oil, a synthetic oil, or a combination thereof.

11. The polymeric compound of claim 10 wherein said extending oil is a mineral oil comprising paraffinic or naphthenic oil.

12. The polymeric compound of claim 1 comprising: 100 parts by weight of the at least one block copolymer (a) and the at least one controlled distribution block copolymer (b) wherein (a) and (b) are both selectively hydrogenated and wherein the controlled distribution block copolymer is present in an amount of less than or equal to 50 parts by weight; and about 5 to about 400 parts by weight of a polymer extending oil.

13. The polymeric compound of claim 1 comprising: 100 parts by weight of the at least one block copolymer (a) and the at least one controlled distribution block copolymer (b) wherein (a) and (b) are both selectively hydrogenated and wherein the controlled distribution block copolymer is present in an amount of less than or equal to 50 parts by weight; and about 400 to about 3000 parts by weight of a polymer extending oil.

14. The polymeric compound of claim 1 comprising: 100 parts by weight of the at least one block copolymer (a) and the at least one controlled distribution block copolymer (b) wherein (a) and (b) are both selectively hydrogenated and wherein the controlled distribution block copolymer is present in an amount of less than or equal to 50 parts by weight; and about 5 to about 100 parts by weight of an olefin polymer.

15. The polymeric compound of claim 14 further comprising about 5 to about 50 parts by weight of a tackifying resin.

16. The polymeric compound of claim 15 further comprising about 1 to about 20 parts by weight of an olefin wax.

17. The polymeric compound of claim 1 comprising: 100 parts by weight of the at least one block copolymer (a) and the at least one controlled distribution block copolymer (b) wherein (a) and (b) are both unhydrogenated and wherein the controlled distribution block copolymer is present in an amount of less than or equal to 50 parts by weight; and about 5 to about 100 parts by weight of an styrenic polymer.

18. The polymeric compound of claim 14 further comprising about 5 to about 300 parts by weight of a polymer extending oil.

19. An article comprising the polymeric compound of claim 1.

20. An article comprising the polymeric compound of claim 12.

21. An article comprising the polymeric compound of claim 18.
